(19) United States
(12) Patent Application Publication
(10) Pub. No.: US 2023/0127060 A1
(43) Pub. Date: Apr. 27, 2023

(54) UREA CYCLE AUGMENTING COMPOSITION AND METHODS OF USE

(71) Applicant: Panoptic Ag Solutions LLC, Bartow, FL (US)

(72) Inventors: Joshua Steinbronn, Winter Haven, FL (US); Bradley Maag, Lakeland, FL (US)

(73) Assignee: Panoptic Ag Solutions LLC, Bartow, FL (US)

(21) Appl. No.: 17/956,221

(22) Filed: Sep. 29, 2022

Related U.S. Application Data
(60) Provisional application No. 63/270,369, filed on Oct. 21, 2021.

(51) Int. Cl. C05C 11/00

(52) U.S. Cl. CPC C05C 11/00

(57) ABSTRACT

A urea cycle augmenting composition for improving plant growth and yields and quality of crops includes a urea cycle augmenting composition, which comprises two or more of L-arginine, L-ornithine, L-aspartic acid, L-citrulline, L-argininosuccinic acid, and agmatine, or salts or derivatives thereof. An amount of the composition applied to a seed or a plant is sufficient to augment the urea cycle of a plant growing from the seed or the plant.

### CROSS-REFERENCE TO RELATED APPLICATIONS

I hereby claim the benefit under 35 U.S.C. Section 119(e) of U.S. Provisional application 63/270,369 filed on Oct. 21, 2021.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to enzymatic cycle augmenting compositions and more particularly pertains to a new enzymatic cycle augmenting composition for improving plant growth, plant quantity and quality of crop yield. Nitrogen is one of the primary nutrients required for plant growth and ultimately, yield. Available nitrogen and the plant uptake of nitrogen are yield often limiting factors in crop production. From 1900 to 2000, global nitrogen fertilizer use has increased approximately 100 fold. Most crop species, in particular grain crop species such as corn, wheat, and rice, require significant amounts of applied nitrogen.

Application of N-(n-butyl) phosphoric triamide, a urease enzyme inhibitor, with urea-based fertilizers to prevent their degradation by soil microorganisms is one method used to retain applied nitrogen in the soil and available to the plant. Another method involves changing tillage practices to build organic matter in the soil, allowing applied nitrogen to bind to organic and clay compounds to prevent leaching. Yet another method is breeding plants to more efficiently uptake and utilize nitrogen. Lastly, genetically engineered endophytic microorganisms, which fix atmospherically available nitrogen directly within the plant, are being developed. However, this is a costly exercise and relies on the colonization and proliferation of the microorganism in plant tissues.

No significant investigations into exploiting nitrogen pathways common within all plants to improve efficiency of nitrogen uptake have been performed. Surprisingly, it has been found that relatively low concentrations of specific compounds involved in the urea cycle of plants significantly improve uptake of nitrogen, health, and overall yield of plant species, especially under nitrogen limiting conditions. These compounds comprise the L-amino acids arginine, aspartic acid, citrulline, ornithine, and argininosuccinic acid, along with the decarboxylation product of arginine, agmatine. Exogenous application of two or more of these compounds dramatically increases uptake and utilization of nitrogen by plants, leading ultimately to increased crop production. Also surprisingly, these combinations impact the growth of leguminous crop species, which receive the bulk of their nitrogen from symbiotic Rhizobium spp.

### (2) Description of Related Art Including Information Disclosed Under 37 CFR 1.97 and 1.98

The prior art relates to enzymatic cycle augmenting compositions for use in plants, and in particular compositions that augment the urea cycle in plants. The prior art does not include compositions specifically intended to augment the urea cycle in plants but does include several compositions directed to feeding nitrogen compounds, including amino acids, their derivative, and their polymers, into the urea cycle.

The prior art includes commercially available protein hydrolysates, both plant and animal derived. The amino acids obtained by protein hydrolysis are proteogenic and present in relatively defined ratios. Protein hydrolysates are applied as a fertilizer to provide nitrogen in an organic form to plants, but do not augment specific physiological processes to promote plant growth. Protein hydrolysates generally include L-arginine and L-aspartic acid, but do not include the non-proteogenic amino acids L-ornithine, L-citrulline, and L-argininosuccinic acid, nor do they include agmatine. Additionally, protein hydrolysis is not capable of producing mixtures of amino acids comprising only two to four amino acids.

U.S. Pat. No. 5,783,523 claims methods and compositions to enhance hydroponic plant productivity with polymers of amino acids. More specifically, water soluble copolymers consisting of a non-acidic amino acid and an acidic amino acid, wherein the acidic amino acid constitutes at least about 20 mole percent of the copolymer. The copolymer has a molecular size larger than about 1,500 Daltons, with a preferred molecular size of about 9,319 Daltons. The non-acidic amino acid may be lysine, arginine, histidine, or derivatives thereof. The acidic amino acid may be aspartic acid. This reference does not teach compositions comprising monomeric amino acids or compositions comprising amino acids and agmatine.

US Application Pub. No. 2021/188726 claims water dispersible compositions comprising sulfur, at least one amino acid or derivative, and a surfactant, to improve the growth, strength, health, and nutritive value of crops, wherein the composition has a particle size in the range of from 0.1-20 microns. It thus is not anticipated that compositions comprising as few as two monomeric amino acids, in the absence of sulfur and a surfactant, would improve crop yields. Additionally, this reference does not teach compositions comprising agmatine and one to four monomeric amino acids.

U.S. Pat. No. 6,241,795 claims a dry concentrated fertilizer comprising nitrogen compounds, phosphorus compounds, potassium compounds, secondary nutrients, micronutrients, and a growth enhancing mixture, wherein the growth enhancing mixture comprises vitamins and at least one component selected from the group consisting of growth promoters, amino acids, carbohydrates, polysaccharides, and adjuvants. Useful amino acids are noted as alanine, arginine, aspartic acid, betaines, choline, cysteine, glutamic acid, glycine, histidine, isoleucine, leucine, lysine, methionine, phenylalanine, proline, serine, threonine, tryptophan, tyrosine, and valine. It thus is not anticipated that compositions comprising as few as two monomeric amino acids, in the absence of nitrogen compounds, phosphorus compounds, potassium compounds, secondary nutrients, micronutrients, and vitamins, would improve crop yields. Additionally, this reference does not teach compositions comprising agmatine and one to four monomeric amino acids.

US Application Pub. No. 2013/0303377 claims combinations of amino acids comprising at least one amino acid selected from a first group consisting of glutamine, asparagine, and histidine, and at least one amino acid selected from a second group consisting of glutamine, asparagine, histidine, arginine, glutamic acid, aspartic acid, and lysine. It thus is not anticipated that compositions comprising as few as two monomeric amino acids, which do not comprise an amino acid selected from the first group, would improve crop yields. Additionally, this reference does not teach compositions comprising agmatine and one to four monomeric amino acids.

### BRIEF SUMMARY OF THE INVENTION

An embodiment of the disclosure meets the needs presented above by generally a composition comprising two or more of L-arginine, L-ornithine, L-aspartic acid, L-citrulline, L-argininosuccinic acid, and agmatine, or salts or derivatives thereof. These compositions specifically target and augment the urea cycle of plants to improve plant growth and yield. The compositions are appliable to seeds, roots, or foliage of a plant to increase a growth rate of the plant. Methods of application include seed treatment, application to soil at planting and/or during the growing season, foliar application, and fertigation. The compositions can be applied alone, or as a mixture with one or more of a fertilizer, an adjuvant, an oil, a pesticide, such as a fungicide, an insecticide, or an herbicide, and the like.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a comparative picture view of a control plot and treated plot from a 2019 Pennsylvania Grain Corn Trial.

FIG. 2 is a comparative picture view of corn roots at the R4 corn growth stage for a control corn plant and for a treated corn plant from the 2019 Pennsylvania Grain Corn Trial.

FIG. 3 is a flow diagram for a method utilizing an embodiment of the disclosure.

### DETAILED DESCRIPTION OF THE INVENTION

An embodiment of the disclosure meets the needs presented above by generally comprising a urea cycle augmenting composition, which comprises two or more of L-arginine, L-ornithine, L-aspartic acid, L-citrulline, L-argininosuccinic acid, and agmatine, or salts or derivatives thereof. An amount of the composition applied to a seed or a plant is sufficient to augment the urea cycle of a plant growing from the seed or the plant.

The composition generally comprises two of L-arginine, L-ornithine, L-aspartic acid, L-citrulline, L-argininosuccinic acid, and agmatine, or the salts or the derivative thereof, although the present invention anticipates the composition comprising three, four, or five of L-arginine, L-ornithine, L-aspartic acid, L-citrulline, L-argininosuccinic acid, and agmatine, or the salts or the derivative thereof.

The composition may comprise one of L-arginine and L-ornithine, or the salts or the derivative thereof, L-arginine and agmatine, or the salts or the derivative thereof, L-citrulline and L-aspartic acid, or the salts or the derivative thereof, L-ornithine and L-citrulline, or the salts or the derivative thereof, and L-citrulline and L-arginine, or the salts or the derivatives thereof, L-arginine and L-aspartic acid, or the salts or derivatives thereof. L-argininosuccinnic acid and L-arginine, or the salts or the derivatives thereof, L-argininosuccinnic acid and L-aspartic acid, or the salts or the derivatives thereof, L-argininosuccinnic acid and L-ornithine, or the salts or the derivatives thereof, L-argininosuccinnic acid and L-citrulline, or the salts or the derivatives thereof,

The composition generally comprises an aqueous solution of the two or more of L-arginine, L-ornithine, L-aspartic acid, L-citrulline, agmatine, and L-argininosuccinic acid or the salts or the derivatives thereof, although the present invention also anticipates the composition being in dry form, such as, but not limited to, powders, granules, pellets, and the like. The present invention also anticipates the composition comprising one or more of a fertilizer, an adjuvant, an oil, a fungicide, an insecticide, an herbicide, and the like.

In use, the urea cycle augmenting composition enables a method of augmenting the urea cycle in a plant. The method comprises a first step of providing a urea cycle augmenting composition according to the specification above. A second step of the method is applying an amount of the composition to one or both of a seed, annual or perennial plant which is sufficient to augment the urea cycle of the plant.

The composition may be in the form of an aqueous solution and applied to one or both of a plurality of seeds and a plurality of plants by one or more of soaking the seeds, spraying soil proximate to the plants at time of planting of the seeds, spraying soil proximate to the plants during the growing season, spraying foliage of the plants during the growing season, incorporation of the composition into a fertilizer solution used for fertigation of the plants during the growing season, incorporation of the composition in or or onto dry fertilizer used for fertilization of plants during the growing season or injecting to irrigation or hydroponic solutions. The method of augmenting the urea cycle in a plant may comprise an additional step of a between one and twenty additional applications of the composition to the plurality of plants during the growing season.

The composition is applied to the plurality of plants at a rate equivalent to more than 1.0 g of the two or more of L-arginine, L-ornithine, L-aspartic acid, L-citrulline, agmatine, and L-argininosuccinic acid or the salts or the derivative thereof, per acre. The composition may be applied to the plurality of plants at a rate equivalent to between 5.0 g and 1000.0 g of the two or more of L-arginine, L-ornithine, L-aspartic acid, L-citrulline, agmatine, and L-argininosuccinic acid or the salts or the derivative thereof, per acre. The composition may be applied to the plurality of plants at a rate equivalent to between 10.0 g and 60.0 g of the two or more of L-arginine, L-ornithine, L-aspartic acid, L-citrulline, agmatine, and L-argininosuccinic acid or the salts or the derivative thereof, per acre.

Provided below are detailed examples of the urea cycle augmenting compositions and methods for their use in greenhouse and field trials. These examples should not be viewed as limiting in regard to compositions, methods, or plant species.

### I. Definitions

CHK stands for check and represents the untreated control for a trial. LSD stands for least significant difference and C.V. stands for Coefficient of Variance. “a” denotes the corresponding value is significantly different from any other value that does not contain the letter “a”. Similarly, “b” denotes the corresponding value is significantly different from any other value that does not contain the letter “b”.

### II. Greenhouse Trials

### A. Replicated Field Corn Greenhouse Trial

Table 1 below presents the results of this trial. Corn seeds (n=20) were planted singly in 6-inch pots using commercial potting soil and were allowed to grow to the 3rd collared leaf stage. Fertilizer (30 grams 20-20-20 NPK fertilizer/gallon of water) was applied at 50 mLs to each pot. Plants were watered to maintain consistent moisture levels in the soil. All treatments in Table 1 are listed by weight % in water and were applied at 0.32 ml of which was further diluted in 1 liter of water and was soil applied to the pot in the form of a drench at 50 mL to each pot. The plants were harvested fourteen days after treatment.

Trial Conclusions: The combination of L-citrulline and potassium aspartate was superior to the combination of L-arginine and L-ornithine in promoting growth of greenhouse corn plants under the conditions of this trial.

TABLE 1

| Treatment | | Plant | Change |
|---|---|---|---|
| # | Treatment Composition | Biomass (g) | (g, %) |
| 1 | CHK | 31.46 b | — |
| 2 | 11% L-arginine | 33.12 ab | 1.66 g, 5.3% |
| | 2.2% L-ornithine HCl | | |
| 3 | 7.4% L-citrulline | 36.80 a | 5.34 g, 17.0% |
| | 7.4% potassium aspartate | | |
| 4 | 7.4% 2:1 L-citrulline:DL | 35.37 ab | 3.91 g, 12.4% |
| | malate | | |
| | 7.4% potassium aspartate | | |
| 5 | 7.4% L-citrulline | 34.88 ab | 3.42 g, 10.9% |
| | 7.4% L-aspartic acid | | |
| 6 | 7.4% 2:1 L-citrulline:DL | 33.78 ab | 2.32 g, 7.4% |
| | malate | | |
| | 7.4% aspartic acid | | |
| LSD | | 5.585 | |
| P = 0.05 | | | |
| C.V. | | 1.531 | |

### B. Replicated Soybean Greenhouse Trial—1

Table 2 below presents the results of this trial. Soybean seeds (n=20) were planted singly in 6-inch pots using commercial potting soil and were allowed to grow to the 2nd trifoliate stage. Fertilizer (30 grams 20-20-20 NPK fertilizer/gallon of water) was applied at 50 mLs to each pot. Plants were watered to maintain consistent moisture levels in the soil. All treatments in Table 2 are listed by weight % in water and were applied at 0.32 ml of which was further diluted in 1 liter of water and was soil applied to the pot in the form of a drench at 50 mL to each pot. The plants were harvested fourteen days after treatment.

Trial Conclusions: Combinations of L-citrulline and aspartic acid promoted significant soybean plant growth, regardless of the presence of a counterion or the counterion if a salt form was used in preparing the solution. The combinations of L-citrulline (or salts) and aspartic acid (or salts) were superior to the combination of L-arginine and L-ornithine in promoting growth of greenhouse grown soybean plants under the conditions of this trial.

TABLE 2

| Treatment | | Plant | Change |
|---|---|---|---|
| # | Treatment Composition | Biomass (g) | (g, %) |
| 1 | CHK | 5.63 b | — |
| 2 | 11% L-arginine | 5.87 ab | 0.24 g, 4.3% |
| | 2.2% L-ornithine HCl | | |
| 3 | 7.4% L-citrulline | 6.54 a | 0.91 g, 16.2% |
| | 7.4% potassium aspartate | | |
| 4 | 7.4% 2:1 L-citrulline:DL | 6.82 a | 1.19 g, 21.1% |
| | malate | | |
| | 7.4% potassium aspartate | | |
| 5 | 7.4% L-citrulline | 6.92 a | 1.29 g, 22.9% |
| | 7.4% L-aspartic acid | | |
| 6 | 7.4% 2:1 L-citrulline:DL | 6.68 a | 1.05 g, 18.7% |
| | malate | | |
| | 7.4% aspartic acid | | |
| LSD | | 5.585 | |
| P = 0.05 | | | |
| C.V. | | 1.531 | |

### C. Replicated Soybean Greenhouse Trial—2

Table 3 below presents the results of this trial. Soybean seeds (n=20) were planted singly in 6-inch pots using commercial potting soil and were allowed to grow to the 2nd trifoliate stage. Fertilizer (30 grams 20-20-20 NPK fertilizer/gallon of water) was applied at 50 mLs to each pot. Plants were watered to maintain consistent moisture levels in the soil. All treatments were applied as a foliar spray at 0.4 mL per 250 mL of water, until runoff.

Trial Conclusions: The combination of L-arginine and L-ornithine was superior to the combination of L-citrulline and L-aspartic acid in promoting soybean plant growth.

TABLE 3

| Treatment | Treatment | Plant | Change |
|---|---|---|---|
| # | Composition | Biomass (g) | (g, %) |
| 1 | CHK | 11.7 b | — |
| 2 | 11% L-arginine | 16.2 a | 4.5 g, 38.4% |
| | 2.2% of L-ornithine | | |
| | HCl | | |
| 3 | 7.4% L-citrulline | 13.3 b | 1.6 g, 13.7% |
| | 7.4% of L-aspartic | | |
| | acid | | |
| LSD | | 5.585 | |
| P = 0.05 | | | |
| C.V. | | 1.531 | |

### D. 2021 Greenhouse Corn Trial—1

Table 4 presents the results of this corn trial. Corn seeds (n=20) were planted singly in 6-inch pots using commercial potting soil and were allowed to grow to the 2nd leaf growth stage. Fertilizer (30 grams 20-20-20 NPK fertilizer/gallon of water) was applied at 50 mLs to each pot. Plants were watered to maintain consistent moisture levels in the soil. Treatment 1 is the untreated control. Treatment 2 comprised a 7.4% agmatine sulfate in water, 0.32 mL of which was further diluted to 1 L with water and was soil applied to the pot in the form of a drench at 50 mL per pot.

Trial Conclusions: Application of agmatine sulfate to plants increased plant biomass, root length, and root tips by 8.79 grams (17.8%), 75.13 cm (5.0%), and 251.00 (3.6%), respectively.

TABLE 4

| | | Plant | Root | |
|---|---|---|---|---|
| Trt | | Biomass | length | Root |
| # | Treatment | (g) | (cm) | Tips |
| 1 | CHK | 49.26 a | 1505.72 a | 7061.9 a |
| 2 | 7.4% agmatine | 58.05 b | 1580.85 a | 7312.9 a |
| | sulfate | | | |
| LSD | | 6.46 | 195.64 | 857.96 |
| P = 0.05 | | | | |
| C.V. | | 14.75 | 15.52 | 14.62 |

### E. 2021 Greenhouse Corn Trial—2

Table 5 presents the results of this corn trial. Corn seeds (n=20) were planted singly in 6-inch pots using commercial potting soil and were allowed to grow to the 2nd leaf growth stage. Fertilizer (30 grams 20-20-20 NPK fertilizer/gallon of water) was applied at 50 mLs to each pot. Plants were watered to maintain consistent moisture levels in the soil. All treatments were applied as at 0.32 ml per 1 L of water and was soil applied to the pot in the form of a drench at 50 mL per pot. Treatment 1 is the untreated control. Treatment 2 comprised a 7.4% agmatine sulfate in water, 0.32 mL of which was further diluted to 1 L with water and was soil applied to the pot in the form of a drench at 50 mL per pot. Treatment 3 comprised a 7.4% agmatine sulfate and 7.4% L-arginine in water, 0.32 mL of which was further diluted to 1 L with water and was soil applied to the pot in the form of a drench at 50 mL per pot.

Trial conclusions: Application of agmatine sulfate alone changed plant biomass, root length, root tips and basal stem diameter by +3.93 g (12.4%), +9.1 cm (1.2%), ˜47.5 (−1.35%), and +0.44 mm (3.9%), respectively. Application of the L-arginine along with the agmatine sulfate changed plant biomass, root length, root tips and basal stem diameter by +3.73 g (11.8%), +123.5 cm (16.4%), +679.8 (19.4%), and +0.53 mm (4.7%), respectively. Both treatments improved desirable plant characteristics, primarily in upper plant biomass, as would be anticipated with increased nitrogen uptake. Interestingly, Treatment 3 promoted increases in other characteristics including root length, number of root tips, and basal stem diameter, all of which allow a plant to explore a larger volume of soil to access to a greater amount of nutrients.

TABLE 5

| | | Plant | Root | | Basal |
|---|---|---|---|---|---|
| | | Biomass | Length | Root | Diameter |
| Trt # | Treatment | (g) | (cm) | Tips | (mm) |
| 1 | CHK | 31.68 b | 754.18 b | 3512.1 a | 11.19 b |
| 2 | agmatine | 35.61 a | 763.25 b | 3464.6 a | 11.63 a |
| | Sulfate | | | | |
| 3 | Arginine/ | 35.41 a | 877.64 a | 4191.9 a | 11.72 a |
| | agmatine | | | | |
| | Sulfate | | | | |
| LSD | | 2.60 | 94.47 | 712.0 | 0.43 |
| P = 0.05 | | | | | |
| C.V. | | 8.96 | 13.98 | 20.57 | 4.37 |

### III. Field Trials

### A. 2020 Nebraska Corn Field Trial.

Table 6 below presents the results this corn field trial. Corn seed was standard fungicide/insecticide treated. Fertilizer application was uniform for all plots. The plot design for this trial was 4 replications with each replicate being 4 rows by 50 feet long. The arginine/ornithine solution was knifed into the soil of Plot 2 to simulate a “side dress” or root delivery at a rate of 1 pint of the arginine/ornithine per acre (˜52 grams and ˜10.4 grams, respectively, of L-arginine and L-ornithine HCl). The arginine/ornithine solution was applied at the 5th emerged/collared leaf stage.

Trial conclusions: Treatment with the arginine/ornithine solution at a relatively low dose per acre provided an increase in yield of almost 4%.

TABLE 6

| | | Yield | Yield |
|---|---|---|---|
| Plot | Treatment | (bushels/acre) | Change/acre |
| 1 | CHK | 206.18 a | — |
| 2 | 11% L-arginine | 214.33 b | 8.15 bushels |
| | 2.2% L-ornithine | | 456.4 lbs |
| | HCl | | (3.95%) |
| LSD | | 6.576 | |
| P = 0.05 | | | |
| C.V. | | 1.39 | |

### B. 2019 South Dakota Corn Field Trial

Table 7 below presents the results of this corn field trial. The plot design for this trial was 4 replications with each replicate being 4 rows by 50 feet long. Plot 1 is an untreated control with nitrogen applied at a rate of 175 lbs/acre in the growing season. This is a standard nitrogen fertilizer application rate consistent with grower standard practices in the area. Plot 2 is a second untreated control with nitrogen applied an applied at rate of 220 lbs/acre in the growing season. For Plot 3, nitrogen also applied at a rate of 175 lbs/acre in the growing season. Additionally, 1 pint of the arginine/ornithine solution (˜52 grams and ˜10.4 grams, respectively of L-arginine and L-ornithine HCl) was diluted to 10 gallons with water. The diluted arginine/ornithine solution then was applied to the foliage of the corn plants of Plot 3 at the 5th collared leaf growth stage using an application rate of 10 gallons per acre.

Trial Conclusions: Arginine/ornithine treatment at a relatively low dose per acre provided an increases in yield of 23.33 bushels per acre (13.0%) and 4.1 bushels per acre (2.06%) for Plot 3 relative to control Plots 1 and 2, respectively. Comparing Plot 3 (arginine/ornithine treated) to Plot 2 (second control), Plot 3 received ˜52 grams and ˜10.4 grams, respectively, of L-arginine and L-ornithine per acre, while Plot 2 had an additional 45 lbs of nitrogen/acre, providing 13.0% and 10.7% increases in yield, respectively, for Plot 3 and Plot 2 relative to Plot 1. This points to substantially increased efficiency in nitrogen uptake and absorption by the plant.

TABLE 7

| Plot | | Yield |
|---|---|---|
| # | Treatment | (bushels/acre) |
| 1 | CHK - 1: nitrogen | 179.67 b |
| | 175 lbs/acre | |
| 2 | CHK - 2: nitrogen | 198.90 a |
| | 220 lbs/acre | |
| 3 | nitrogen 175 lbs/acre | 203.00 a |
| | 11% L-arginine | |
| | 2.2% L-ornithine HCl | |
| LSD | | 8.933 |
| P = 0.05 | | |
| C.V. | | 2.03 |

### C. 2020 Michigan Sugar Beet Trial

Table 8 below presents the results of this sugar beet trial. The plot design for this trial was 6 replications with each replicate being 4 rows by 25 feet long. Plot 1 was an untreated control and Plot 2 was treated with the arginine/ornithine solution at the 2nd true leaf growth stage.

Trial Conclusions: The application of the Arginine/Ornithine formulation increased yield by 7.18 tons/acre (30.6%), recoverable sugars by 5.1 lbs/ton (2.3%), and overall sugar yield by 1,690.1 lbs/acre (32.2%).

TABLE 8

| | | Yield | Recoverable | Sugar |
|---|---|---|---|---|
| Plot | | (Tons/ | Sugar | Yield |
| # | Treatment | Acre) | (lbs/ton) | (lbs/acre) |
| 1 | CHK | 23.65 b | 220.02 a | 5251.7 b |
| 2 | 11% L-arginine | 30.83 a | 225.12 a | 6941.8 a |
| | 2.2% L-ornithine | | | |
| | HCl | | | |
| LSD | | 3.70 | 7.13 | 883.46 |
| P = 0.05 | | | | |
| C.V. | | 9.14 | 2.15 | 9.76 |

### D. 2019 Louisiana Sugarcane Trial

Table 9 below presents the results of this sugarcane trial, which used a common sugarcane variety (L01-299). The crop was in the 1st ratoon/1st stubble stage meaning that it had been commercially harvested for the 1st time in 2018, also known as plant cane. In early April, Plots 1 and 3 received 120 lbs/acre of nitrogen in the form of UAN 28 (Urea-Ammonium Nitrate) and considered the grower standard. Thereafter, Plot 1 served as an untreated control. For Plot 2, the arginine/ornithine solution was mixed with the UAN (1 pint arginine/ornithine solution/120 lbs UAN), with the resultant mixture then being applied at a rate at 120 lbs/acre of nitrogen to the soil. For Plot 3, approximately 6 weeks after the nitrogen application, the arginine/ornithine solution was applied at 1 pint/acre to the foliage utilizing a high-boom sprayer. Each plot was approximately 1 acre in size and replicated 4 times per treatment.

TABLE 9

| | | | Recover- | Sugar | |
|---|---|---|---|---|---|
| | | Yield | able | Yield | |
| Plot | | (Tons/ | Sugar | (lbs/ | Fiber |
| # | Treatment | Acre) | (lbs/Ton) | acre) | (%) |
| 1 | CHK | 28.96 b | 211.5 a | 6086.79 b | 18.02 a |
| 2 | 11% L-arginine | 34.46 a | 224.7 a | 7735.76 a | 17.48 b |
| (Soil) | 2.2% L- | | | | |
| | ornithine HCl | | | | |
| 3 | 11% L-arginine | 35.58 a | 214.8 a | 7456.56 a | 18.54 a |
| (Foliar) | 2.2% L- | | | | |
| | ornithine HCl | | | | |
| LSD | | 4.5 | 29.98 | 957.03 | 0.56 |
| P = 0.15 | | | | | |
| C.V. | | 11.86 | 10.34 | 13.49 | 2.65 |

Trial Conclusions: Even though the applications were separated by several weeks and different application methodologies, soil verses foliar, the arginine/ornithine solution produced comparable results in terms of increasing total tons per acre and sugar yield per acre.

### E. 2020 Nebraska Soybean Trial

Table 10 below presents the results of this soybean trial. The field was planted at a seeding rate of 150,000 plants per acre as was uniform throughout the trial. The plot design for this trial was 4 replications with each replicate being 4 rows by 30 feet long. In soybeans, nitrogen is not typically applied to the crop due to nitrogen fixation by the air of the symbiotic bacteria, Rhizobium spp. Plot 1 served as an untreated control. Plots 2 and 3 were treated with the arginine/ornithine solution at a rate of 1 pint/acre to the foliage of the plant. The applications were performed at the V3 (3rd trifoliate) and R1 (bloom) growth stages, respectively.

Trial conclusions: Foliar application of (the arginine/ornithine solution at the V3 and R1 growth stages increased yield by 20.25% and 15.12%, respectively. The large increases in yield are consistent with the arginine/ornithine solution promoting nitrogen fixation by Rhizobium.

TABLE 10

| Plot | | Yield | Change |
|---|---|---|---|
| # | Treatment | (bushels/acre) | (bushels/acre) |
| 1 | CHK | 67.67 b | — |
| 2 | 11% L-arginine | 81.37 a | 13.70 |
| (V3) | 2.2% L-ornithine | | |
| | HCl | | |
| 3 | 11% L-arginine | 77.90 ab | 10.23 |
| (R1) | 2.2% L-ornithine | | |
| | HCl | | |
| LSD | | 10.52 | |
| P = 0.05 | | | |
| C.V. | | 6.13 | |

### F. 2020 Michigan Potato Field Trial

Table 11 below presents the results of this replicated potato field trial. The plot design for this trial was 6 replications with each replicate being 4 rows by 25 feet long. The crop was grown and maintained using grower standard practices for the area. Yield is expressed as hundredweight (cwt) per acre. Plot 1 served as an untreated control and Plot 2 was treated with the arginine/ornithine solution at a rate of 1 pint per acre to the foliage of the plants during bloom.

Trial conclusions: The application of the arginine/ornithine solution increased desirable yield, US #1 grade, by 57.4 cwt/acre (15.4%) and total yield by 82.7 cwt/acre (18.1%).

TABLE 11

| | | Yield | Yield | Total |
|---|---|---|---|---|
| | | US #1s | US #2s | Yield |
| Plot | | (cwt/ | (cwt/ | (cwt/ |
| # | Treatment | acre) | acre) | acre) |
| 1 | CHK | 373.9 b | 83.8 a | 457.7 b |
| 2 | 11% L-arginine | 431.3 a | 109.1 a | 540.4 a |
| | 2.2% L-ornithine | | | |
| | HCl | | | |
| LSD | | 45.0 | 50.9 | 26.9 |
| P = 0.05 | | | | |
| C.V. | | 7.54 | 35.5 | 3.63 |

### G. 2020 California Almond Field Trial

Table 12 below presents the results of this almond field trial. The crop was grown and maintained using grower standard practices for the area. The trial was designed as six replications per treatment, each replicate representing one tree. Yield is expressed as lbs/acre and is the meats yield, the saleable portion of the crop. Plot 1 served as an untreated control. Plot 2 was treated four times (March, April, May, and June) with the arginine/ornithine solution at a rate of 1 pint per acre to the foliage of the plants, coincident with fertigation nitrogen applications. Treatments were performed utilizing a high-volume water sprayer delivering 100 gallons per acre.

Trial conclusions: The sequential application of the arginine/ornithine solution increased saleable yield by 219 lbs/acre.

TABLE 12

| Plot | | Saleable Yield |
|---|---|---|
| # | Treatment | (lbs/acre) |
| 1 | CHK | 3638.7 b |
| 2 | 11% L-arginine | 3858.2 a |
| | 2.2% L-ornithine | |
| | HCl | |
| LSD | | 130.34 |
| P = 0.05 | | |
| C.V. | | 2.34 |

### H. 2020 California Table Grape Trial

Table 13 below presents the results of this table grape trial. The field was grown and maintained using grower standard practices for the area. The trial was conducted as 6 replications per treatment, each replicate representing one vine. Plot 1 served as an untreated control. Plot 2 was treated with the arginine/ornithine solution at 1 quart per acre two times during the berry sizing process.

Trial conclusion: The application of the arginine/ornithine solution increased the yield by 107.89 boxes per acre (18.2%).

TABLE 13

| Plot | | Yield |
|---|---|---|
| # | Treatment | (Boxes/Acre) |
| 1 | CHK | 592.97 b |
| 2 | 11% L-arginine | 700.86 a |
| | 2.2% L-ornithine HCl | |
| LSD P = 0.05 | | 104.65 |
| C.V. | | 1.68 |

### I. 2019 Pennsylvania Grain Corn Trial

Table 14 below presents the results of a grain corn trial. The plot design for this trial was 4 replications with each replicate being 4 rows by 25 feet long. The trial was unique in that the soil utilized for the trial was heavily composted over the previous years and no fertilizer was applied to the trial. Plot 1 served as an untreated control. Plot 2 was treated with the arginine/ornithine solution at 1 quart per acre at the V5 (5th collared leaf) growth stage.

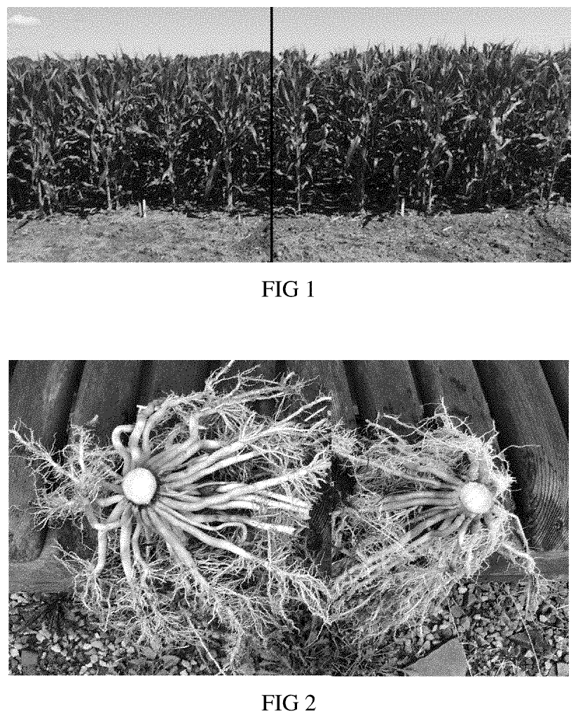

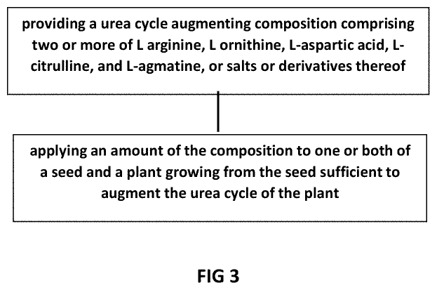

Trial conclusions: The arginine/ornithine solution increased plant height (inches), stalk girth, and yield while reducing moisture. Shown in FIG. 1 are pictures of Plot 1 (left) and Plot 2 (right) at the R1 growth stage. Of note the improvement in plant height and number of tassels for Plot 2 (treated with arginine/ornithine solution) relative to the untreated plants of Plot 1. Shown in FIG. 2 are pictures of corn roots at the R4 corn growth stage from this trial. For the arginine/ornithine treated plant (left), there is a significant increase in root size and stalk girth comparted to the untreated plant (right).

TABLE 14

| | | Plant | Stalk | Moisture | Yield |
|---|---|---|---|---|---|
| Plot | | Height | Girth | at Harvest | (bu/ |
| # | Treatment | (in) | (in) | (%) | acre) |
| 1 | CHK | 109.1 b | 0.919 b | 20.06 b | 162.7 b |
| 2 | 11% L-arginine | 120.9 a | 1.082 a | 18.34 a | 198.1 a |
| | 2.2% L-ornithine | | | | |
| | HCl | | | | |
| LSD | | 1.49 | 0.068 | 1.0875 | 31.2 |
| P = 0.10 | | | | | |
| C.V. | | 1.58 | 8.28 | 2.37 | 7.25 |

An interesting aspect to this trial was that no synthetic fertilizer was applied, showing the ability of the arginine/ornithine solution increase nitrogen uptake, plant growth and overall yield in high organic matter soils. After noticing a severe yellowing in the cover crop for Plot 2 the following spring (2020), soil samples were analyzed. Table 15 shows the results of this analysis. Of note, the soil nitrate and soil nitrogen levels were reduced in Plot 2 relative to Plot 1. Also of note, the other primary plant nutrients, phosphorus, and potassium, were not dramatically reduced in Plot 2, indicating that nitrogen uptake was the rate limiting step in plant production.

TABLE 15

| Spring Soil | Nitrate | Nitrogen | Phosphorus | Potassium |
|---|---|---|---|---|
| Test (2020) | (ppm) | (%) | (ppm) | (ppm) |
| Plot 1 | 44.4 | 0.26 | 84 | 227 |
| Plot 2 | 4.7 | 0.22 | 96 | 331 |

### J. 2022 Replicated Field Corn Greenhouse Trial

Table 16 below presents the results of this trial. Corn seeds (n=20) were planted singly in 6-inch pots using commercial potting soil and were allowed to grow to the 3^{rd} leaf stage. Fertilizer (30 grams 20-20-20 NPK fertilizer/gallon of water) was applied at 50 mLs to each pot. Plants were watered to maintain consistent moisture levels in the soil. All treatments in Table 2 are listed by weight % in water and were applied at 50 mL to each pot. The plants were harvested fourteen days after treatment.

Trial Conclusions: Various combinations of agmatine, L-aspartic acid, L-arginine, L-citrulline, L-ornithine significantly increased the biomass of corn plants when compared to the untreated check.

TABLE 16

| Treatment | Treatment | Shoot Mass | Change |
|---|---|---|---|
| # | Composition | (Grams) | (g/%) |
| 1 | CHK | 37.1 b | |
| 2 | 11% L-arginine | 39.5 a | 2.4 g, 6.4% |
| | 2.2% L-ornithine HCl | | |
| 3 | 7.4% L-arginine | 40.0 a | 2.8 g, 7.6% |
| | 7.4% L-aspartic acid | | |
| 4 | 7.4% L-arginine | 41.3 a | 4.2 g, 11.3% |
| | 7.4% L-citrulline | | |
| 5 | 7.4% L-aspartic acid | 39.6 a | 2.5 g, 6.8% |
| | 7.4% L-citrulline | | |
| 6 | 7.4% L-ornithine HCl | 39.9 a | 2.7 g, 7.4% |
| | 7.4% L-aspartic acid | | |
| 7 | 7.4% L-ornithine | 40.5 a | 3.4 g, 9.2% |
| | 7.4% L-citrulline | | |
| 8 | 7.4% L-arginine | 39.7 a | 2.6 g, 6.9% |
| | 7.4% agmatine sulfate | | |
| LSD | | 1.94 | |
| P = 0.10 | | | |
| C.V. | | 5.01 | |

### K. 2021 Nebraska Corn Field Trial.

Table 17 below presents the results this corn field trial. Corn seed was standard fungicide/insecticide treated. The corn seed was planted at a planting population of 34,000 seeds per acre. Fertilizer application was uniform for all plots. The plot design for this trial was 8 replications with each replicate being 4 rows by 50 feet long. The arginine/ornithine and aspartic/citrulline combinations were applied to the foliage of the corn plants at the 5^{th} leaf growth stage. The amino acid combinations were sprayed at a rate of 16 fl. oz. per acre with 15 gallons of water as the carrier.

Trial conclusions: Treatment with the arginine/ornithine and aspartic acid/citrulline increased plant yield by 12.4 bushels per acre and 8.4 bushels per acre, respectively.

TABLE 17

| | | Yield | Yield |
|---|---|---|---|
| Plot | Treatment | (bushels/acre) | Change/acre |
| 1 | CHK | 232.7 b | — |
| 2 | 11% L-arginine | 245.2 a | 12.5 bushels |
| | 2.2% L-ornithine HCl | | (5.4%) |
| 3 | 7.4% L-aspartic acid | 242.1 a | 9.4 bushels |
| | 7.4% L-citrulline | | (4.0%) |
| LSD | | 8.63 | |
| P = 0.10 | | | |
| C.V. | | 4.08 | |

Although the foregoing invention has been described in some detail by way of illustration and example for purposes of clarity and understanding, it will be readily apparent, in light of the teachings of this invention, that certain changes and modifications may be made thereto without departing from the spirit or scope of the following claims. For example, the present invention anticipates the L-amino acids being supplied as part of a racemic mixture.

I claim:

1. A urea cycle augmenting composition comprising two or more of L-arginine, L-ornithine, L-aspartic acid, L-citrulline, L-argininosuccinic acid, and agmatine, or salts or derivatives thereof, wherein an amount of the composition applied to a seed or a plant is sufficient to augment the urea cycle of a plant growing from the seed or the plant.

2. The urea cycle augmenting composition of claim 1, wherein the composition comprises two of L-arginine, L-ornithine, L-aspartic acid, L-citrulline, L-argininosuccinic acid, and agmatine, or the salts or the derivatives thereof.

3. The urea cycle augmenting composition of claim 2, wherein the composition comprises one of:
L-arginine and L-ornithine, or the salts or the derivatives thereof;
L-arginine and agmatine, or the salts or the derivatives thereof;
L-arginine and L-aspartic acid, or the salts or derivatives thereof;
L-citrulline and L-aspartic acid, or the salts or the derivatives thereof;
L-citrulline and L-ornithine, or the salts or the derivatives thereof;
L-citrulline and L-arginine, or the salts or the derivatives thereof;
L-argininosuccinic acid and L-arginine, or the salts or derivatives thereof;
L-argininosuccinic acid and L-aspartic acid, or the salts or derivative thereof;
L-argininosuccinic acid and L-ornithine, or the salts or derivatives thereof;
L-argininosuccinic acid and L-citrulline, or the salts or derivatives thereof;

4. The urea cycle augmenting composition of claim 1, wherein the composition comprises an aqueous solution of the two or more of L-arginine, L-ornithine, L-aspartic acid, L-citrulline, L-argininosuccinic acid, and agmatine, or the salts or the derivatives thereof.

5. The urea cycle augmenting composition of claim 1, further including the composition comprising one or more of a fertilizer, an adjuvant, an oil, a fungicide, an insecticide, and an herbicide.

6. A method of augmenting the urea cycle in a plant, the method comprising the steps of:
providing a urea cycle augmenting composition comprising two or more of L-arginine, L-ornithine, L-aspartic acid, L-citrulline, L-argininosuccinic acid, and agmatine, or salts or derivatives thereof; and
applying an amount of the composition to one or both of a seed and a plant growing from the seed sufficient to augment the urea cycle of the plant.

7. The method of claim 6, wherein:
the composition comprises an aqueous solution of the two or more of L-arginine, L-ornithine, L-aspartic acid, L-citrulline, L-argininosuccinic acid, and agmatine, or the salts or the derivatives thereof; and
the composition is applied to one or both of a plurality of seeds and a plurality of plants by one or more of:
soaking the seeds,
spraying soil proximate to the plants at time of planting of the seeds,
spraying soil proximate to the plants during the growing season,
spraying foliage of the plants during the growing season, and
incorporation of the composition into a fertilizer solution used for fertigation of the plants during the growing season.
Incorporation of the composition into or onto a dry fertilizer used for fertilization of the plants during the growing season
Injection into the irrigation water and delivered to the crops

8. The method of claim 7, further including an additional step of between one and five additional applications of the composition to the plurality of plants during the growing season.

9. The method of claim 7, wherein composition is applied to the plurality of plants at a rate equivalent to more than 1.0 g of the two or more of L-arginine, L-ornithine, L-aspartic acid, L-citrulline, L-argininosuccinic acid, and agmatine, or the salts or the derivatives thereof, per acre.

10. The method of claim 9, wherein composition is applied to the plurality of plants at a rate equivalent to between 5.0 g and 1000.0 g of the two or more of L-arginine, L-ornithine, L-aspartic acid, L-citrulline, L-argininosuccinic acid, and agmatine, or the salts or the derivatives thereof, per acre.

11. The method of claim 10, wherein composition is applied to the plurality of plants at a rate equivalent to between 10.0 g and 60.0 g of the two or more of L-arginine, L-ornithine, L-aspartic acid, L-citrulline, L-argininosuccinic acid, and agmatine, or the salts or the derivatives thereof, per acre.

12. The composition of claim 1, wherein an amount of the composition applied to the seed or the plant is sufficient to increase one or more of plant biomass, plant nitrogen uptake, quantity of yield from a plant, and quality of yield from the plant growing from the seed or the plant.
